(19) United States
(12) Patent Application Publication
(10) Pub. No.: US 2011/0007109 A1
(43) Pub. Date: Jan. 13, 2011

(54) APPARATUS, SYSTEM, AND METHOD FOR COOLING AND HEATING

(76) Inventors: Craig J. Shields, Chicago, IL (US); Gary W. Pritchard, Rockwall, TX (US); Thomas F. Lewis, Portage, IN (US); Thomas J. Kucklick, Chicago, IL (US)

Correspondence Address: HOLLAND & KNIGHT LLP, 10 ST. JAMES AVENUE, BOSTON, MA, 02116-3889, US

(21) Appl. No.: 12/501,139

(22) Filed: Jul. 10, 2009

(51) Int. Cl. B41J 29/377; F28F 27/00

(52) U.S. Cl. 347/18; 165/244

(57) ABSTRACT

The present disclosure is generally directed towards an apparatus for use in printing systems. The apparatus may include an ink filter having an ink chamber configured to allow ink to flow therethrough and a coolant chamber configured to allow coolant to flow therethrough. The coolant chamber may be further configured to cool ink in the ink chamber. Numerous other embodiments are also within the scope of the present disclosure.

### TECHNICAL FIELD

This disclosure relates to a system and method for cooling and heating. More specifically, the present disclosure relates to cooling and heating fluids in a filtration device.

### BACKGROUND

Some systems require fluids running through the system to be cooled or heated. For example, in existing printing systems, heat may be produced as components of the printing system make contact with each other. For example, in some printing systems, printing presses, rolls, blades, plates, cylinders, dryers, and other press components may generate heat. Further, the room in which the printing system is located may generate heat.

In many printing systems, ink filters or similar filters may be used to filter unwanted particles from ink, coating, or adhesive that have been generated during the printing process. For example, in flexographic and gravure printing or coating processes some particularly effective ink filters include Graymills™ HSFT, HFNT, HFLT, DDPSFST, and DDPSFNT filters, available from Graymills Corporation of Chicago, Ill. These ink filters may be capable of receiving this excessively heated ink, coating, or adhesive from various components within the printing system.

Accordingly, the heat generated throughout the printing system may be transferred to the ink, coating, or adhesive used in those printing systems. In some cases, intense, localized heat may be transferred to the ink, coating, or adhesive by various printing system components. The quality of a particular print job may be negatively affected by an unwanted increase in the ink temperature. In other situations, it may actually be required that the ink, coating, or adhesive is heated.

### SUMMARY OF DISCLOSURE

In a first implementation an apparatus may comprise an ink filter including an ink chamber configured to allow ink to flow therethrough. The ink filter may further include a coolant chamber configured to allow coolant to flow therethrough. The coolant chamber may be configured to cool ink associated with the ink chamber.

One or more of the following features may be included. The coolant chamber may be configured to receive coolant at a coolant inlet and output coolant at a coolant outlet. The ink chamber may be further configured to receive ink from an ink tank and output ink to a printing station. In some embodiments, the coolant chamber may have a tubular configuration. Moreover, the coolant chamber may be operatively connected to an ink filter cover configured to enclose the ink in the ink chamber.

In other embodiments, the ink filter may be operatively connected with at least a portion of an ink line. The ink line may have at least one sensor device associated therewith.

In a second implementation, a printing system may include an ink filter operatively connected to a printing station via an ink line. The ink filter may include an ink chamber and a coolant chamber. The ink chamber may be configured to receive ink from an ink tank and output ink to a printing station. Further, a sensor device may be associated with the ink line. A valve, in communication with the sensor device, may be configured to allow coolant into the coolant chamber. In some embodiments, a controller may be in communication with the sensor device and the valve. The controller may be configured to open and close the valve based upon, at least in part, a characteristic measured by the sensor device. A coolant unit may be configured to supply coolant to the coolant chamber through the valve.

One or more of the following features may be included. An ink pump may be configured to supply ink from the ink tank. Further, a viscosity controller may be configured to control the viscosity of the ink.

In a third implementation, an apparatus is provided including a machine tool heat-transfer-fluid filter. The machine tool heat-transfer-fluid filter may include a heat-transfer-fluid chamber and a coolant chamber. The machine tool heat-transfer-fluid chamber may be configured to allow heat-transfer-fluid to flow therethrough. The coolant chamber may be configured to allow coolant to flow therethrough. The coolant chamber may be further configured to cool heat-transfer-fluid in the heat-transfer-fluid chamber.

One or more of the following features may be included. A sensor device may be associated with a machine tool heat-transfer-fluid line. The machine tool heat-transfer-fluid filter may be configured to include at least a portion of the machine tool heat-transfer-fluid line. Further, a valve may be configured to allow coolant into the coolant chamber. In some embodiments, the valve may be in communication with the sensor device. Moreover, a controller may be in communication with the sensor device and the valve. The controller may be configured to open and close the valve based upon, at least in part, a characteristic measured by the sensor device. Additionally, a coolant unit may be configured to supply coolant to the coolant chamber.

In a fourth implementation, a method for cooling ink in a printing system may include receiving ink at an ink filter. The method may further comprise receiving coolant at a coolant chamber within the ink filter. One or more of the following features may be included. The method may include measuring a characteristic of the ink with a sensor device. The method may further comprise controlling a flow of the coolant into the coolant chamber based upon, at least in part, the measured characteristic of the ink.

In some embodiments, the flow of the coolant into the coolant chamber may be controlled by a valve in communication with the sensor device. In other embodiments, the flow of the coolant into the coolant chamber may be controlled by a controller in communication with the sensor device and a valve. Additionally, the measured characteristic may at least one of temperature, pressure, flow, mass flow, pH, viscosity, and humidity.

In a fifth implementation an apparatus may comprise a chamber configured to be operatively connected to a filtration device. The filtration device may be configured to allow filter fluid to flow therethrough. The chamber may be further configured to allow temperature-altering-fluid to flow therethrough and to alter the temperature of the filter fluid associated with the filtration device. At least a portion of the chamber may be inside the filtration device.

One or more of the following features may be included. The filtration device may be at least one of an ink filter, a coating filter, and an adhesive filter. The filter fluid may be at least one of ink, coating, and adhesive.

### BRIEF DESCRIPTION OF THE DRAWINGS

FIG. 1 is diagram showing an apparatus in accordance with an embodiment of the present disclosure;

FIG. 2 is a diagram showing components of an apparatus in accordance with an embodiment of the present disclosure;

FIG. 3 is a diagram showing components of an apparatus in accordance with another embodiment of the present disclosure;

FIG. 4 is a diagram showing a printing system in accordance with an embodiment of the present disclosure;

FIG. 5 is a flow chart showing a method in accordance with an embodiment of the present disclosure; and

FIG. 6 is diagram showing an apparatus in accordance with an embodiment of the present disclosure.

### DETAILED DESCRIPTION OF THE PREFERRED EMBODIMENTS

Generally, the present disclosure relates to a system and method for cooling and heating. More specifically, the present disclosure relates to cooling and heating fluids in a filtration device. The present disclosure also relates to a system and method for cooling ink, coating, or adhesive in an ink filter associated with a printing system.

The term “ink” as used herein may refer to a colored material used in a printing process. For example, some types of ink may include any and all types of water-based, solvent-based, ultraviolet (UV), and electron beam (EB) curable inks such as those used in flexographic and rotogravure printing processes. The term “coating” as used herein may refer to different types of coatings used in a printing process. For example, some types of coating may include over print varnish, water based coating, acrylic based coating, solvent based coating, aqueous coating, ultra-violet (UV), and electron beam (EB) curable coating. The term “adhesive” as used herein may refer to different types of adhesives used in a printing process. For example, some types of adhesive may include laminating adhesives, UV curable adhesives, and light curing adhesives. These inks, coatings, and adhesives are merely provided for exemplary purposes as the present disclosure is not intended to be limited to these types of inks, coatings and adhesives.

While the various figures and embodiments of the present disclosure are described herein with respect to ink, this is for illustrative purposes only. The features of the present disclosure may be equally applicable to other fluids such coating, adhesive, or other fluids used in a printing process.

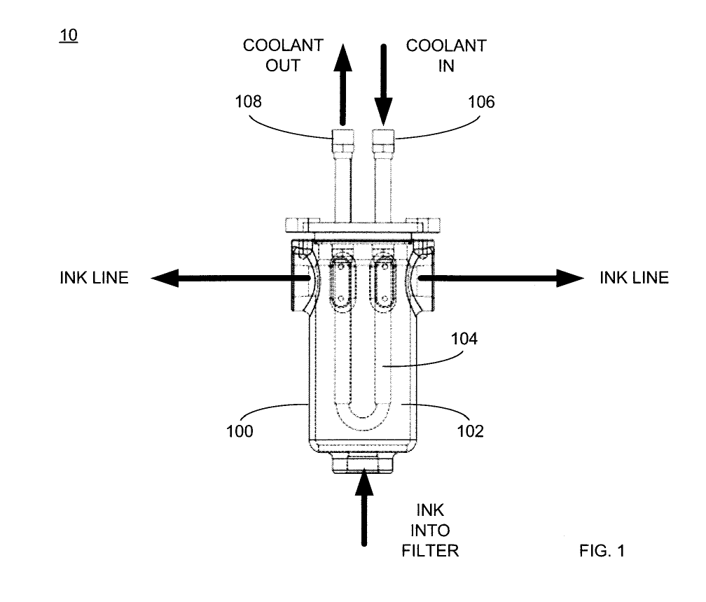

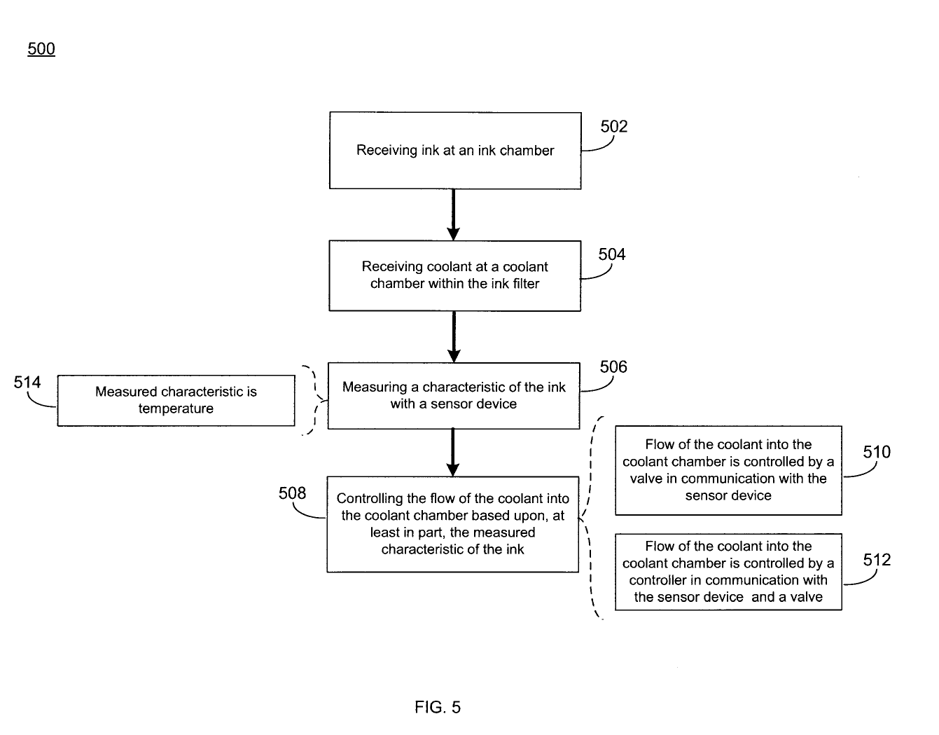

Referring now to FIGS. 1 and 5, apparatus 10 may include ink filter 100 configured to allow ink to flow therethrough during a printing process. Ink filter 100 may be configured to filter unwanted particles from the ink that have been generated during the printing process. In some embodiments, ink filter 100 may be Teflon coated, and may be designed to overcome pressure drop and reduced ink flow due to clogging that may occur during the flow of ink.

In some embodiments, ink filter 100 may include ink chamber 102, and coolant chamber 104. Ink chamber 102 and coolant chamber 104 may be designed or configured in such a way that ink flowing through ink chamber 102 may be cooled by coolant flowing through coolant chamber 104.

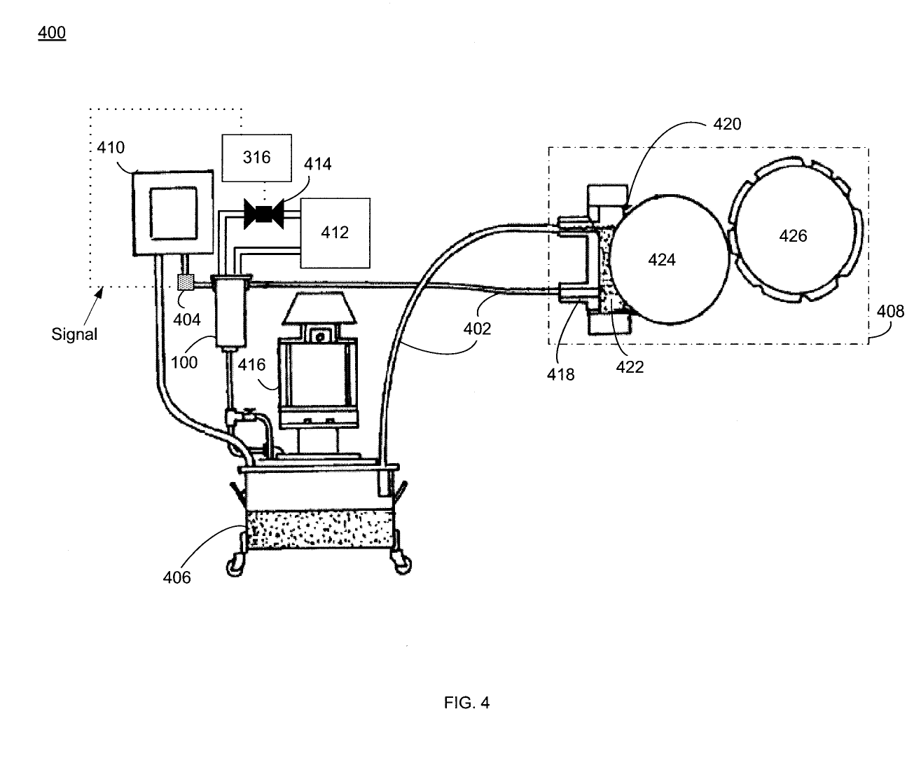

Ink chamber 102 may define a portion of ink filter 100 though which ink flows. In some embodiments, ink chamber 102 may be designed or configured to receive (502) ink from an ink tank and output ink to a printing station (as shown in FIG. 4). Ink chamber 102 may be constructed in a variety of different shapes and configurations such as the circular configuration shown in FIG. 1. Numerous other configurations are also within the scope of the present disclosure. Ink chamber 102 may define a portion of the space inside ink filter 100 where ink accumulates or sits when flow through ink filter 100 is stagnant.

Coolant chamber 104 may be any portion of ink filter 100 through which coolant flows and, as such, may be configured to receive (504) coolant from a coolant source. The term “coolant” as used herein may refer to any temperature altering fluidic substance. Coolant chamber 104 may be configured to receive coolant at coolant inlet 106 and to output coolant at coolant output 108. The coolant flowing through coolant chamber 104 may include, but is not limited to, any type of heat-transfer-fluid or other coolant known in the art, or any type of coolant used in the ink or printing industry. The coolant may take any number of forms such as a liquid or gas. For example, some coolants may include, but are not limited to antifreezes (e.g., ethylene glycol, diethylene glycol, propylene glycol), water, deionized water, polyalkylene glycol, oils, mineral oils, silicone oils, fluorocarbon oils, and cutting fluid, or any combination thereof. Additionally, some gas coolants may include, but are not limited to air, hydrogen, helium, nitrogen, carbon dioxide, sulfur hexafluoride, and steam, or any combination thereof. The coolant may also be a refrigerant, such as freon.

Ink filter 100 may also include a number of additional components. For example, ink filter 100 may include a magnet (not shown) to trap particles which may be in the ink. Moreover, ink filter 100 may include an ink filter cartridge (not shown) to trap filtered material. The ink filter cartridge may be made from stainless steel, and may have a mesh screen.

As mentioned above, the various figures and features of the present disclosure may be equally applicable to other fluids such as coating or adhesive. For example, ink filter 100 may be a filtration device designed to filter other fluids besides ink, such as coating or adhesive (i.e., a coating filter or an adhesive filter). Further, ink chamber 102 may be a chamber through which various fluids flow, such as coating, or adhesive (i.e., filter fluid). Further, coolant chamber 104 may be a chamber through which fluids besides coolant flow. For example, in an application in which it may be desired to heat ink, coating, adhesive (i.e., filter fluid), the fluid flowing through coolant chamber 104 may be any temperature-altering-fluid. For example, in a heating application, the temperature-altering-fluid may be water, hot water, steam, or any other fluid or gas used for heating purposes.

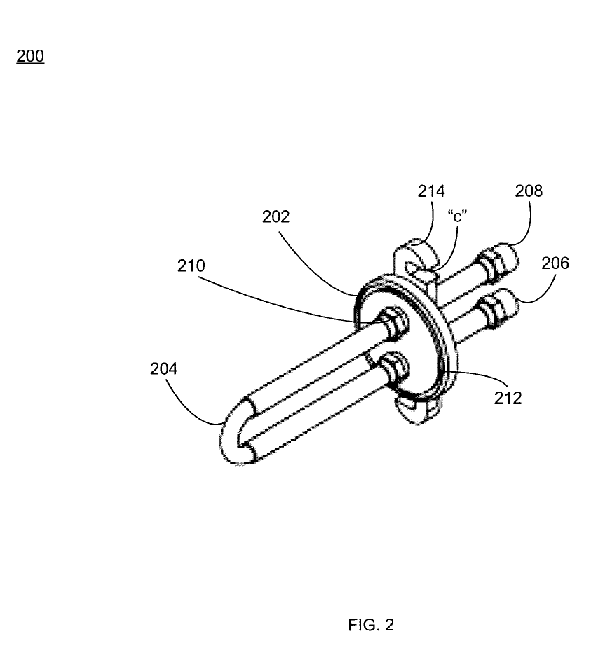

Referring now to FIG. 2, an embodiment depicting cooling mechanism 200 of ink filter 100 is provided. Cooling mechanism 200 may include an ink filter cover 202 operatively connected to coolant chamber 204. Ink filter cover 202 may be configured to seal ink within ink chamber 102 as shown in FIG. 1. Coolant chamber 204 may be of any suitable configuration, such as the tubular, substantially U-shaped configuration shown in FIG. 2. Other configurations are possible, for example, coolant chamber 204 may be of a shell and tube configuration, or a plate configuration, as in a shell and tube heat exchanger, or a plate heat exchanger. Coolant chamber 204 may receive coolant through tube inlet 206, and may output coolant through tube outlet 208. In some embodiments, tube inlet 206 and tube outlet 208 may be extensions of coolant chamber 204 that run through ink filter cover 202. Coolant chamber 204 may be made of any material known in the art, including, but not limited to rubbers, plastics, metals, steels, and polymers. In one or more embodiments, cooling mechanism 200 may include two or more coolant chambers (not shown). For example coolant mechanism 200 may include two or more U-shaped configurations each having its own tube inlet and tune outlet.

In some embodiments, the arrangement of ink filter cover 202 and coolant chamber 204 may allow coolant chamber 204 to be easily cleaned. In this way, removal of ink filter cover 202 from the ink filter (e.g., ink filter 100) may allow an operator to simply rinse coolant chamber 204. Numerous types of cleaning solutions may be used to clean the interior and/or exterior portions of coolant chamber 204.

Ink filter cover 202 may be secured to coolant chamber 204 using any a variety of attachment techniques. For example, coolant chamber 204 may be secured to ink filter cover 202 using a locking mechanism 210 such as a threaded arrangement or any other suitable technique. Ink filter cover 202 may further include a seal 212, which may be configured to provide an air-tight or liquid impermeable connection with the top portion of ink filter 100. Ink filter cover 202 may additionally include an attachment mechanism 214, which may be configured to secure cooling mechanism 200 with ink filter 100. Attachment mechanism 214 may include at least one cavity “c” configured to engage and/or securely mate with a portion of ink filter 100.

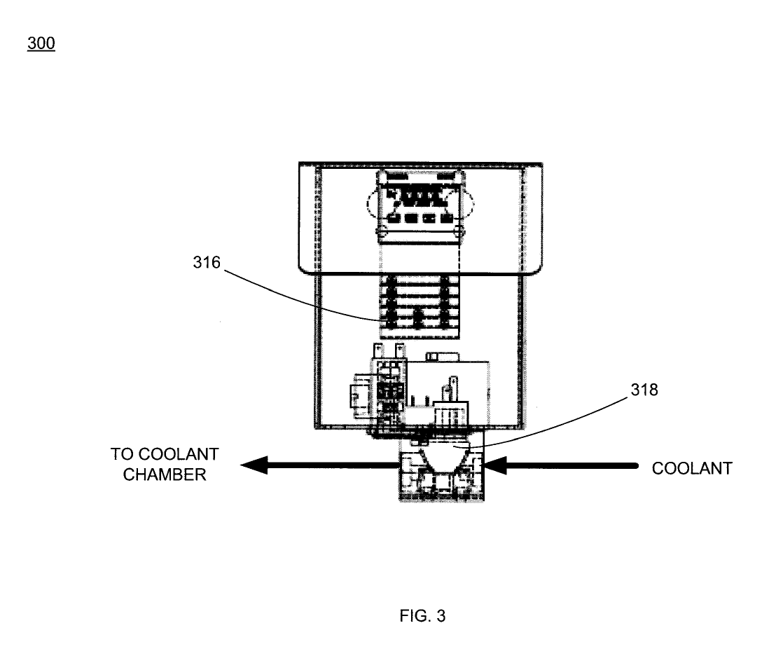

Referring now to FIGS. 3 and 4, an exemplary embodiment of a subsystem 300 including a controller (e.g., controller 316) and a valve (e.g. valve 318) is shown. Subsystem 300 may be operatively connected with ink filter 100 and/or other portions of printing system as shown in FIG. 4. Controller 316 may be in communication with a sensor device (e.g., sensor device 404, shown in FIG. 4). Sensor device 404 may measure a characteristic of ink in the ink line and communicate the characteristic to controller 316. Controller 316 may then transmit a signal to control valve 318, causing valve 318 to open and/or close, thereby controlling the flow of coolant through valve 318. As shown in FIG. 3, coolant may move through valve 318 and to coolant chamber 102 of ink filter 104. In some embodiments, coolant may be supplied by a coolant unit, which may be configured to store coolant, such as water at a desired temperature.

Referring again to FIG. 4, in another implementation a printing system (e.g., printing system 400) may comprise an ink line (e.g., ink line 402) running through an ink filter (e.g., ink filter 100) to a printing station (e.g., printing station 408). The ink filter may be any variation of ink filter 100 mentioned above. Also, and as mentioned above, ink filter 100 may be configured to receive ink from an ink tank (e.g., ink tank 406) and output ink to a printing station (e.g., printing station 408). The printing system may further comprise a sensor device (e.g., sensor device 404) operatively connected to the ink line, and a valve (e.g., valve 414) configured to allow coolant into the coolant chamber (e.g., coolant chamber 104). The valve may be in communication with the sensor device (e.g., sensor device 404). Sensor device 404 may be included anywhere on the ink line, including but not limited to on an inlet pipe, an outlet pipe, a viscosity bypass pipe, or within a filter (i.e., an ink filter) body. The printing system may also include a controller (e.g., controller 316) in communication 426 with the sensor device (e.g., sensor device 404), and the valve (e.g., valve 414). Further, the controller (e.g., controller 316) may be configured to open and close the valve (e.g., valve 414) based upon, at least in part, a characteristic measured by the sensor device (e.g., sensor device 404).

In some embodiments, ink filter 100 may be configured to receive a flow of ink from ink line 402. Ink line 402 may include sensor device 404 associated therewith, which is discussed in further detail below. As discussed above, ink line 402 may be configured to supply and return ink as needed by the various components shown throughout system 400. For example, ink line 402 may include one or more lines that transport ink from a supply, such as ink tank 406, to a printing station 408, such as printing station 408. One or more components may exist along ink line 402 between ink tank 406 and printing station, including but not limited to, viscosity controller 410, one or more sensor devices (e.g. sensor device 404), ink filter 100, and a color controller (not shown). While ink line 402 is shown in FIG. 4 as including two lines, ink line 402 may also include all lines and/or pipes through which ink flows. For example, ink line 402 may also include the line and/or pipe connecting ink tank 406 to viscosity controller 410. Sensor device 404 may be in communication with subsystem 300 using any type of wired or wireless communication signals.

In some embodiments, sensor device 404 may be in communication with valve 414 through controller 316 of subsystem 300. Communication between sensor device 404 and valve 414 may be any type of wired or wireless communication. Valve 414 may be configured to open and/or close based upon, at least in part, a characteristic measured by sensor device 404.

In some embodiments, controller 316 of subsystem 300 may be in communication with sensor device 404 and valve 414. Controller 316 may be configured to control valve 414 (i.e., open and close valve 414) based upon at least in part, the characteristic of the ink measured by sensor device 404. In other words, controller 316 may control (512) the flow of coolant into a coolant chamber (e.g., coolant chamber 104) based upon, at least in part, the characteristic of the ink measured by sensor device 404.

As discussed above, communication between controller 316, sensor device 404, and valve 414 may be any type of wired or wireless communication. For example, communication between any of controller 316, sensor device 404, and valve 414 may follow any communication protocol, including, but not limited to, Ethernet, ControlNet, DeviceNet, or the like. Controller 316 may be any type of industrial controller, including, but not limited to programmable controllers, programmable logic controllers (PLC's), or a controller local to valve 414. Valve 414 may be any type of valve, including but not limited to a solenoid valve, industrial valve, programmable valve, or control valve (e.g., a temperature control valve or pressure control valve).

In some embodiments, the printing system (e.g., printing system 400) may be a flexographic printing system. This type of printing system may include raised rubber or photopolymer plates. The plates may be mounted to a rotating cylinder, and may be inked by a 2-roll system or an enclosed chamber system. In a 2-roll system, an anilox roll may run in an open ink pan. An anilox roll may be a ceramic coated cylinder that has tiny holes, or cells, which are laser etched in it. Excess ink may be metered off by a doctor blade. A doctor blade may be a razor-type blade that runs the length of the roll. Excess ink may also be metered off by a second, rubber metering cylinder.

In an enclosed chamber system, the anilox roll may be mated to an enclosed chamber. Doctor blades on both sides may meter and contain the ink. Ink may transfer from the anilox roll to the plate and then may transfer to a substrate. Ink may be circulated by a pump from an ink tank on the ground up to the chamber or pan. Excess ink (about 95%) may return to the tank with the force of gravity or with the air of a suction device.

In other embodiments, the printing system (e.g., printing system 400) may be a rotogravure, or gravure printing system. This system may be similar to the flexographic system. Here, an engraved roll may circulate through an open ink pan. Ink may fill the engraving. Excess ink may be metered off by a doctor blade. The anilox roll, or cylinder, may directly print on the substrate.

The printing system (e.g., printing system 400) may also include coolant unit 412 to supply coolant to the coolant chamber (e.g., coolant chamber 104) through the valve (e.g., valve 414). In some embodiments, the printing system may use water as a coolant, in which case water of a desired temperature is supplied through the valve. Water may be supplied via coolant unit 412, or via any other source of water. After moving through the coolant chamber (e.g., coolant chamber 104), the coolant may return back to coolant unit 412. In the case where the coolant is water, the water may move back to coolant unit 412, or may move to drain.

Additionally, printing system 400 may include an ink pump (e.g., ink pump 416) configured to supply ink to ink line 402 from ink tank 406. The ink pump may circulate ink through ink line 402 to printing station 408, and ink may return to ink tank 406. The ink pump may be any type of pump used for pumping ink, and may include, but is not limited to centrifugal pumps, positive displacement pumps, and diaphragm pumps.

Printing system 400 may further include a viscosity controller (e.g., viscosity controller 410) configured to control viscosity of ink in the ink line, and a printing station (e.g., printing station 408). Additionally, printing system 400 may include a color controller (not shown), which may be configured to measure and control ink density, printing thickness, and color shade. Printing station 408 may also include a number of components, including those described above for flexographic or rotogravure (gravure) printing systems. For example, printing station 408 may include doctor blade system 418, doctor blade 420, ink chamber 422, anilox roll 424, and plate cylinder 426.

Referring again to FIG. 5 a method 500 in accordance with the present disclosure is provided. As discussed above, sensor device 404 may sense or measure (506) a number of characteristics of ink in the ink line, including but not limited to, temperature, heat, pressure, flow, mass flow, pH, viscosity, or humidity (514). Sensor device 404 may also be a transducer, or a device that converts one type of energy or physical attribute to another for the purpose of measurement or information transfer. By way of example and not limitation, sensor device 404 may be a temperature sensor, including but not limited to, a thermometer, thermocouple, thermistor, resistance temperature detector, bi-metal thermometer, or thermostat. Sensor device 404 may also be a heat sensor, such as a bolometer, calorimeter, or heat flux sensor.

Flow of coolant into a coolant chamber (e.g., coolant chamber 104) may be controlled (508) based upon, at least in part, a characteristic of the ink measured by sensor device 404. Further, valve 414 may control (510) flow of coolant into the coolant chamber (e.g., coolant chamber 104) based upon, at least in part, the characteristic of the ink measured by sensor device 404.

In another implementation, the apparatuses, systems, and methods described herein may be equally applicable to machine tool heat-transfer-fluid systems, also known as machine tool coolant systems. Modem machine tools may require a pumped coolant/lubricant that runs up to the machine tool (i.e., a cutting tool). This should not be confused with hydraulic oil that may be inside the actual machine. The coolant/lubricant may be sprayed on the tool and/or part in order to lubricate the cutting surface. This may result in longer tool life and less heat distortion. The cooler the coolant/lubricant is, the more effective it may be. The coolant/lubricant used in such systems may acquire various types of debris, including metal particles, dust, etc., as it moves through the system. As such, machine tool heat-transfer-fluid systems may require filters to filter out the debris from the heat transfer fluid or coolant/lubricant.

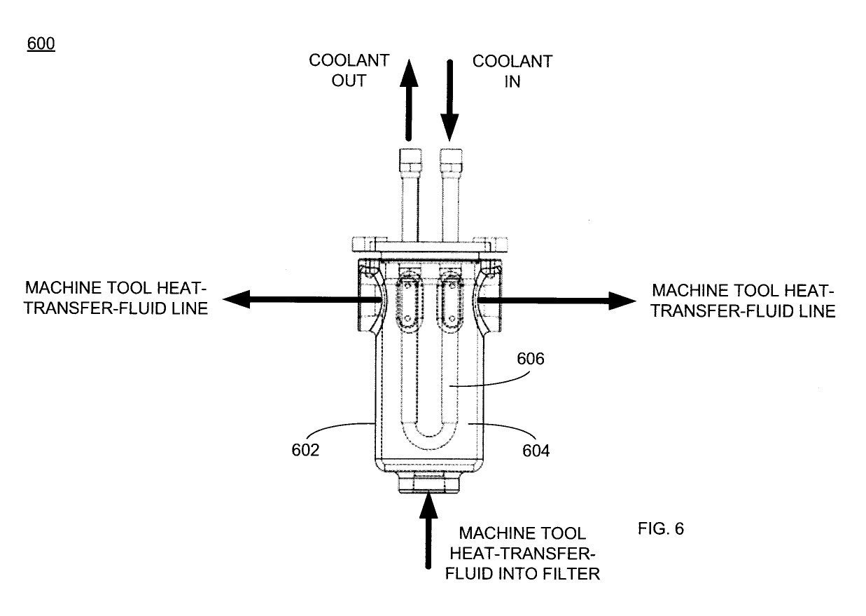

Referring to FIG. 6, a machine tool cooling apparatus 600 is provided. Apparatus 600 may include machine tool heat-transfer-fluid filter 602 having heat-transfer-fluid chamber 604 and coolant chamber 606. Machine tool heat-transfer-fluid chamber 604 may be configured to allow heat-transfer-fluid to flow therethrough. Further, coolant chamber 606 may be configured to allow coolant to flow therethrough. Coolant chamber 606 may be further configured to cool heat-transfer-fluid in heat-transfer-fluid chamber 604. Machine tool heat-transfer-fluid filter 602 may be any type of filter used to filter machine tool heat-transfer-fluids (or machine tool coolants). For example, machine tool heat-transfer-fluid filter 602 may be a Graymills™ Bed Filter, or Bed Filter/Coolant Tank, available from Graymills Corporation out of Chicago, Ill. The configuration in FIG. 6 is shown for illustrative purposes only, and the above mentioned components may take various other forms and may be arranged in various other configurations.

It should be noted that the term “heat-transfer-fluid” as used herein may refer to any temperature altering fluidic substance. Moreover, the term “heat-transfer-fluid” may include any type of coolant such as those used to cool machine tools (i.e., machine tool coolant), any type of lubricant such as those used to lubricate machine tools, or any combination thereof. The heat-transfer-fluid may also include any type of liquid coolant described above. The heat-transfer-fluid should not be confused with the coolant in the coolant chamber, which may be used to cool the heat-transfer fluid. While the heat-transfer-fluid and the coolant may be similar substances, fluids, or may both even be coolants, it is important that the purpose of machine tool heat-transfer-fluid filter 602 may be to filter heat-transfer-fluid that may eventually end up at a machine tool, and to cool this heat-transfer-fluid with the coolant. In some embodiments, the coolant used to cool the heat-transfer-fluid may be water of a desired temperature.

In one embodiment, a sensor device may be operatively connected to a machine tool heat-transfer-fluid line (not shown). The sensor device may be similar to sensor device 404 in FIG. 4, however implemented in a machine tool heat-transfer-fluid system. Machine tool heat-transfer-fluid filter 602 may be configured to include at least a portion of the machine tool heat-transfer-fluid line. A valve may be configured to allow coolant into coolant chamber 606. The valve maybe similar to valve 414 in FIG. 4, however, implemented in a machine tool heat-transfer-fluid system. The valve may be in communication with the sensor device. A controller may be in communication with the sensor device and the valve. The controller may be similar to controller 316, however implemented in a machine tool heat-transfer-fluid system. The controller may be configured to open and close the valve based upon, at least in part, a characteristic measured by the sensor device. A coolant unit may be configured to supply coolant to the coolant chamber through the valve. The coolant unit may be similar to coolant unit 412, however implemented in a machine tool heat-transfer-fluid system.

A number of implementations and embodiments have been described. Nevertheless, it will be understood that various modifications may be made. Accordingly, other implementations are within the scope of the following claims.

What is claimed is:

1. An apparatus comprising:
an ink filter including an ink chamber configured to allow ink to flow therethrough and a coolant chamber configured to allow coolant to flow therethrough, the coolant chamber further configured to cool ink associated with the ink chamber.

2. The apparatus of claim 1 wherein the coolant chamber is configured to receive coolant at a coolant inlet and output coolant at a coolant outlet.

3. The apparatus of claim 1 wherein the ink chamber is configured to receive ink from an ink tank and output ink to a printing station.

4. The apparatus of claim 1 wherein the coolant chamber has at least one of a tubular configuration, a shell and tube configuration, and a plate configuration.

5. The apparatus of claim 4 wherein the coolant chamber is operatively connected to an ink filter cover configured to enclose the ink in the ink chamber.

6. The apparatus of claim 1 wherein the ink filter is operatively connected with at least a portion of an ink line, the ink line having at least one sensor device associated therewith.

7. A printing system comprising:
an ink filter operatively connected to a printing station via an ink line, the ink filter including an ink chamber and a coolant chamber, the ink filter configured to receive ink from an ink tank and output ink to the printing station;
a sensor device operatively connected to the ink line; and
a valve configured to allow coolant into the coolant chamber, the valve in communication with the sensor device.

8. The printing system of claim 7 further comprising an ink pump configured to supply ink from the ink tank.

9. The printing system of claim 7 further comprising a viscosity controller configured to control the viscosity of ink.

10. The printing system of claim 7 further comprising a coolant unit configured to supply coolant to the coolant chamber through the valve.

11. The printing system of claim 7 further comprising a controller in communication with the sensor device and the valve, the controller configured to control the valve based upon, at least in part, a characteristic measured by the sensor device.

12. An apparatus comprising:
a machine tool heat-transfer-fluid filter including a heat-transfer-fluid chamber configured to allow heat-transfer-fluid to flow therethrough and a coolant chamber configured to allow coolant to flow therethrough, the coolant chamber further configured to cool heat-transfer-fluid in the heat-transfer-fluid chamber.

13. The apparatus of claim 12 further comprising:
a sensor device associated with a machine tool heat-transfer-fluid line, the machine tool heat-transfer-fluid filter configured to include at least a portion of the machine tool heat-transfer-fluid line;
a valve configured to allow coolant into the coolant chamber, the valve being in communication with the sensor device;
a controller in communication with the sensor device and the valve, the controller configured to open and close the valve based upon, at least in part, a characteristic measured by the sensor device; and
a coolant unit configured to supply coolant to the coolant chamber.

14. A method for cooling ink in a printing system comprising:
receiving ink at an ink filter; and
receiving coolant at a coolant chamber within the ink filter.

15. The method of claim 14 further comprising:
measuring a characteristic of the ink with a sensor device; and
controlling a flow of the coolant into the coolant chamber based upon, at least in part, the measured characteristic of the ink.

16. The method of claim 15 wherein the flow of the coolant into the coolant chamber is controlled by a valve in communication with the sensor device.

17. The method of claim 16 wherein the flow of the coolant into the coolant chamber is controlled by a controller in communication with the sensor device and a valve.

18. The method of claim 15 wherein the measured characteristic is at least one of temperature, pressure, flow, mass flow, pH, viscosity, and humidity.

19. An apparatus comprising:
a chamber configured to be operatively connected to a filtration device, the filtration device configured to allow filter fluid to flow therethrough, the chamber further configured to allow temperature-altering-fluid to flow therethrough and to alter the temperature of the filter fluid associated with the filtration device, wherein at least a portion of the chamber is inside the filtration device.

20. The apparatus of claim 19 wherein the filtration device is at least one of an ink filter, a coating filter, and an adhesive filter, and wherein the filter fluid is at least one of ink, coating, and adhesive.
